(19) United States
(12) Patent Application Publication
(10) Pub. No.: US 2007/0257854 A1
(43) Pub. Date: Nov. 8, 2007

(54) Method for making antenna of coaxial cable and the antenna so made

(75) Inventor: Pony Guo, Taipei (TW)

Correspondence Address: Pony Guo, P.O.Box 166-13, Taipei, 115, TW

(73) Assignee: Poni Tek Co., Ltd.

(21) Appl. No.: 11/417,100

(22) Filed: May 4, 2006

(51) Int. Cl. H01Q 9/04

(52) U.S. Cl. 343/790; 343/791

(57) ABSTRACT

Price to performance ratio of manufacturing coaxial cable antenna can be improved. A coaxial cable antenna comprising: a coaxial cable having a first end to receive signals, a second end to transmit signals, said first end includes a receiver conductor formed by an end of the coaxial cable peeled off a specific length of braided sheath and outer plastic sheath; a length of peeled braided sheath as a grounding segment, which is following the receiver conductor and folded backward covering a periphery of an outer plastic sheath; said grounding segment is further enclosed by a wrapper, which is in contact with a braided sheath reciprocally. Said second end is connected to a connector. Next, an expander fits over a periphery of a receiver conductor. And a wrapper is joined together by an affixture, which is attached to a planar surface of an object.

### FIELD OF THE INVENTION

The present invention is related to a method for making antenna of coaxial cable and the antenna so made for receiving digital TV (television hereinafter brief as TV) signals.

### BACKGROUND OF THE INVENTION

Recently, the information equipment is developed in the direction of wireless connection, such as data transmission between notebook and the network system, even digital modulation and compression to broadcast audio, video and data signals to TV sets. As the conventional antenna occupied a bulky space is awkwardly to install on these information equipments, so coaxial cables are widely applicable in the scope of digital signal transmission. When a coaxial cable is used as an antenna, it should be designed as two conductor wires, one is to pick up and deliver carrier signals, especially digital signals, the other is to transmit mixed signals of antenna grounding. One end of the coaxial cable is coupled together with a connector in connection with information equipments, while the other end of the coaxial cable is connected to a free end of an antenna.

With reference to FIG. 1, configuration of a coaxial cable 10 is illustrated. A coaxial cable includes a core conductor 1 enclosed by an inner dielectric layer 2, in turn, the inner dielectric layer is further enclosed by a metal woven braided sheath 3, and an outer plastic sheath 4 enclosing the braided sheath 3. A free end of the coaxial cable first is peeled off a specific length of the outer plastic sheath 4, and then remove the inner dielectric layer 2 and the metal woven braided sheath 3, finally, the core conductor 1 is reciprocally separated from the enclosed metal woven braided sheath 3. The core conductor 1 is used to form a digital signal cable, but the metal woven braided sheath 3 is twisted weaved to form a grounding signal cable. Said core conductor land metal woven braided sheath 3 can be coupled to a base of an external antenna. The external antenna as disclosed in U.S. application Ser. No. 11/068,457 entitled “External Antenna” assigned to Pony Guo on Feb. 28, 2005 includes a base, a connector secured to the base, a mast like antenna screwed to the connector, a metal cap embedded into a bottom of the base, and a magnet or sucking disk fit into an open trough of the metal cap; this kind of external antenna equipped with a number of components produced through complicated processes required the manufacturers an estimated larger capital expenditure than had been expected.

Furthermore, coaxial cable applied to the antenna may refer to U.S. Pat. No. 6,281,856 (hereinafter brief as '856) entitled “Method for making antenna of coaxial cable and the antenna so made” assigned to Tang, Chiu-Yu et al. on Aug. 28, 2001, according to FIG. 2D and independent claims 10,18 of '856, after removing an outer jacket at a predetermined length, a braided shield of a second free end of the coaxial cable is exposed out, further electrically connected to a conductor. Said conductor is extended from a braided shield to a corresponding conductor core at a right angle. In other words, conductor is electrically connected to an exposed braided shield perpendicularly.

Conventional external antenna has a complicated structure constructed with components joined together through multi-step process requires the expenditure of time and effort. When facing a price competition on the market, electronic products manufactured at higher unit cost are doomed to have poor selling. Besides, an external antenna has a good poise must be extended from a base occupied bulky space, further a mast like antenna could not be bent or curved at will so that an elongated antenna with a bulky base could not be carried about with the users in person.

Next, aforesaid coaxial cable is only designed for receiving signals from 2.4 G Hz channels at selected locations. Digital TV broadcast, however, is not included within such 2.4 G Hz channels. Moreover, a conventional coaxial cable antenna is possibly shorter and smaller than others, but it only can be used as built-in antenna installed to the information equipments; a length of built-in antenna is limited to a factory-built housing incapable of elongating the antenna for receiving digital TV signals.

As discussed above, a coaxial cable antenna can be carried about in person, and manufactured through an inexpensive, simplified method, further being used to receive broadband digital TV signals is anticipated in the scope of the present invention.

### SUMMARY OF THE INVENTION

Accordingly, the present invention is to provide a coaxial cable antenna 100 comprising: a coaxial cable 10 having a first end 11 to receive signals, a second end 12 to transmit signals, a specific length of bare receiver conductor 5 is exposed at the first end of the coaxial cable by peeling off a braided sheath 3 and an outer plastic sheath 4; said receiver conductor 5 followed by a grounding segment first being led out from a periphery of an inner dielectric layer 2 and then goes through a braided sheath 3 finally the grounding segment folded backward to cover a periphery of an outer plastic sheath 4;

The receiver conductor 5 also followed by a periphery of an outer plastic layer 4 at said first end 11 of coaxial cable, a wrapper 20 is to enclose the periphery of the outer plastic layer 4, and a braided sheath 3 is also hidden inside the wrapper in contact therewith;

A connector 30 connected to a second end 12 of said coaxial cable 10, the connector 30 can be plugged into or pulled out at will in order to transmit signals.

According to aforesaid coaxial cable antenna 100, an expander 40 with elastic facility fits over a periphery of said receiver conductor 5, the expander is elastically stretched to an original length to upright the receiver conductor 5 being flush with the expander therethrough.

According to aforesaid coaxial cable antenna 100, an affixture 50 is provided to adjust a degree of wrapper 20 and bare conductor receiver 5, said affixture 50, which is a positioning device coupled to the wrapper 20, is affixed to a planar surface of an object.

A method for making coaxial cable antenna comprises following steps:
(a) getting an appropriate length of coaxial cable 10 having a first end 11 and a second end 12;
(b) peeling off an outer plastic sheath 4 at the first end 11 of the coaxial cable 10;
(c) peeling off a braided sheath 3 and folding the peeled braided sheath 3 backward to cover a periphery of an outer plastic sheath 4, thereby a core conductor at the first end 11 of a bare coaxial cable is exposed to form a segment of receiver conductor 5;
(d) enclosing a wrapper 20 to a periphery of outer plastic sheath 4 following the receiver conductor 5, the braided sheath 3 is also hidden inside the wrapper and in contact with the wrapper;
(e) connecting a second end 12 of a coaxial cable 10 to a connector 30 for transmitting signals.

### CONTRAST BETWEEN THE PRESENT INVENTION AND PRIOR ARTS

The advantage and benefits can be obtained by realizing the present invention as following:

A specific length of an outer plastic sheath 4 is peeled off at a first end 11 of the coaxial cable 10, a length of a braided sheath 3 is also peeled off, but this peeled braided sheath 3 is folded backward to cover a periphery of an outer plastic sheath 4 ensuing peeled first end to form a grounding segment. Thereby the first end is remained with a bare receiver conductor 5 for receiving high frequency signals. A specific length of the receiver conductor 5 can be applied to adjust received signal strength, but a specific length of braided sheath 3 covering a periphery of an outer plastic sheath 4 following the receiver conductor is applied to adjust Q factor (quality factor of a resonant system, hereinafter brief as Q factor) of a tuned frequency, thereby impedance matching between said braided sheath 3 and the receiver conductor 5 can be used to receive broad band signals with sufficient gain. The first end of a coaxial cable can be processed to form an external antenna connected to a digital TV.

Besides, a wrapper 20 enclosing a peeled braided sheath 3, which is folded backward to cover the periphery of an outer sheath 4 following the peeled first end, can also be applied to adjust tuned frequency, further providing a decoration and protection mechanism.

The receiver conductor 5 and the coaxial cable 10 has a preferrable flexibility, both the receiver conductor 5 and the cable 10 can be bent and curved at will, therefore, it can be carried about in person by users.

An affixture 50 can be joined together to a wrapper 20, either a magnet 54, or sucking disk 55, or double sided tape 56 etc., further can be adapted to an affixture 50 to attach to a planar surface of an object. Thereby, an affixture 50 adjusted at an angle can affect the orientation of a receiver conductor 5 and a wrapper 20 to guarantee high quality digital TV program viewed by the users.

The present invention is aimed to simplify the manufacturing process, therefore, to reduce amount of required components, further lower the unit price by saving labor and capital costs, but the coaxial cable antenna still can be used to receive high quality digital TV signalr. Price to performance ratio of manufacturing antenna can be improved by the present invention.

### BRIEF DESCRIPTION OF DRAWINGS

FIG. 1: shows a sectional view of a conventional coaxial cable antenna;

FIG. 2: shows a schematic view of a coaxial cable antenna of the present invention;

FIG. 3: shows an enlarged sectional view of an antenna of a first embodiment of the present invention;

FIG. 4: shows an enlarged sectional view of an antenna of a second embodiment of the present invention;

FIG. 5: shows an enlarged sectional view of an antenna of a third embodiment of the present invention;

FIG. 6: shows an enlarged sectional view of an antenna of a fourth embodiment of the present invention;

FIGS. 7˜8: show enlarged sectional views of two coaxial cable antennas of the fifth embodiment of the present invention;

FIGS. 9˜10: show enlarged sectional views of two coaxial cable antennas of the sixth embodiment of the present invention;

FIGS. 11˜15: show enlarged sectional views of the seventh embodiment of the present invention;

FIG. 16: shows a schematic view of coaxial cable antenna of the present invention in use; and

FIGS. 17A˜D: show diagrammatic blocks views of manufacturing the coaxial cable antenna of the present invention.

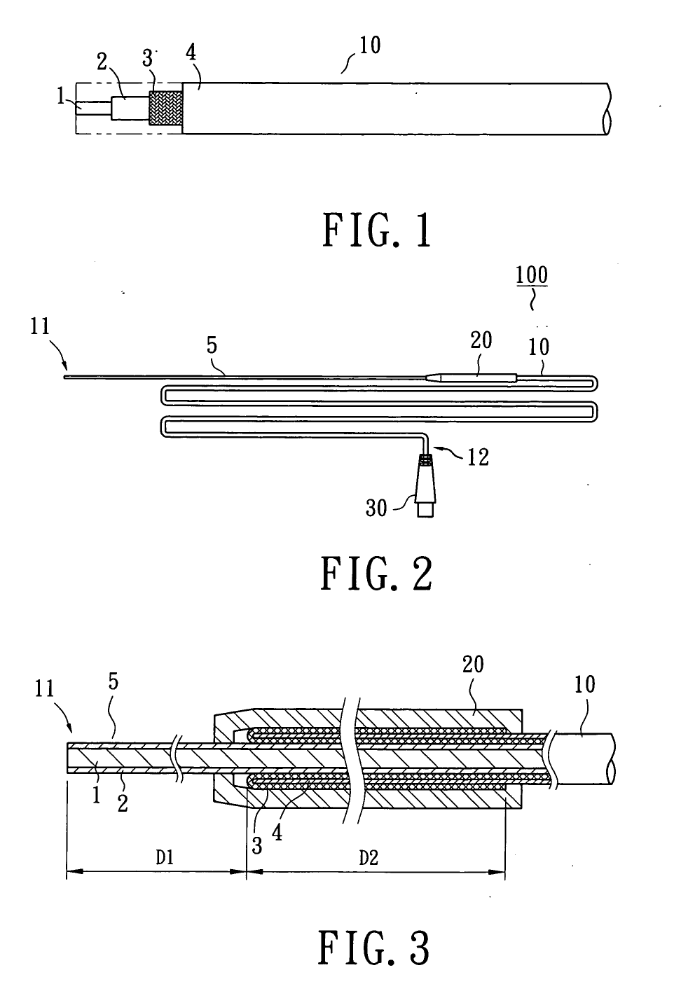

### DETAILED DESCRIPTION OF THE PREFERRED EMBODIMENTS

The description is described in detail according to the appended drawings as following:

As shown in FIG. 2, a schematic view of the antenna of the present invention is illustrated. In which, a coaxial cable antenna 100 mainly designed for receiving wireless signals of digital TV (Television, hereinafter brief as TV), said digital TV includes DVBT (Digital Video Broadcasting Television), ATSC (Advanced Television System Committee), ISDB (Integrated Service Digital Broadcasting). The coaxial cable antenna 100 comprisies a coaxial cable 10 having a first end 11 for receiving signals, a second end 12 for transmitting signals; a wrapper 20 for enclosing a coaxial cable 10 near a first end 11 thereof; a connector 30 connected to a second end 12 of the coaxial cable 10. Said coaxial cable antenna 100 is flexible in essence, thereby the antenna can be curved, bent even to wear on the neck as a necklace.

### First Embodiment

As shown in FIG. 3, an enlarged sectional view of a coaxial cable antenna of the first embodiment of the present invention is illustrated. In which, a first end 11 of the coaxial cable 10 includes a segment of receiver conductor 5 first peeling off a braided sheath 3 and an outer plastic sheath 4. A braided sheath 3 following said receiver conductor 5 is applied to enclose a periphery of an inner dielectric layer 2. Said braided sheath 3 further is led out and folded backward to cover a periphery of an outer plastic sheath 4 to form a grounding segment, said grounding segment is further enclosed by a wrapper 20, a braided sheath 3 is hidden inside the wrapper 20 and in contact therewith.

Said receiver conductor 5 comprises a conductor core 1 enclosed by an inner dielectric layer 2. A specific length D1 of said conductor core 1 is relative to strength of received signals, while a specific length D2 of said braided sheath 3 folded backward to cover a periphery of an outer plastic sheath 4 is relative to a Q factor (quality factor of a resonant system, hereinafter brief as Q factor) of tuned frequency. Thereby, impedance matching between the receiver conductor 5 and the braided sheath 3 can be determined based on the specific lengths D1, D2, which are further pre-determined according to the specific requirements of the objects that are employed. Therefore, when manufacturing, a manufacturer should give a specific length of D1, D2 respectively. Said specific length D2 covering a periphery of an outer plastic sheath 4 in a folded backward inclinatioin, even the length D2 is not enclosed by a wrapper 20, the specific length D2 still can be applied to adjust Q factor of tuned frequency. However, a wrapper 20 can be added to protect a braided sheath 3, or the braided sheath 3 can be further decorated with a wrapper 20. Thereby the coaxial cable antenna 100 can be prevented from wearing and tearing to achieve a safety effect. The wrapper 20 further can be applied to adjust tuned frequency. When a length of a braided sheath 3 covering a periphery of an outer plastic sheath 4 in a folded back inclination is shorter than a required length; a wrapper 20 made from metal likely a conductor can be electrically connected to the hidden inside braided sheath 3 to adjust Q factor of tuned frequency.

Said wrapper 20 encloses a periphery of an outer plastic sheath 4 following a first end of the coaxial cable 10 (i.e. grounding segment), further a folded backward braided sheath 3 as a covering is hidden inside the wrapper 20, thereby, the wrapper 20 is in contact with said braided sheath 3. When a wrapper 20 made from metal can be applied as a conductor, it can be electrically connected to the braided sheath 3 hidden inside to adjust tuned frequency. Conversely, while a wrapper 20 made from rubber to form a nonconductor, it can be used to decorate and protect the braided sheath 3. A wrapper can be made from copper foil, metal duct, or carbon fiber duct etc., to form a conductor. A wrapper can also be made from rubber tube, contracted film, or foam layer etc., to form a non-conductor.

Said connector 30 is connected to a second end 12 of the coaxial cable 10 as a connector can be plugged into and pulled out at will for transmission of signals. Such as F/IEC (RF radio frequency connector used for cable television usually with RG-6/U or RG-59/U cable defined by international Electrotechnical Commission) connector, plug, or high frequency connector all of them can be connected to information system such as digital TV, top set box.

### Second Embodiment

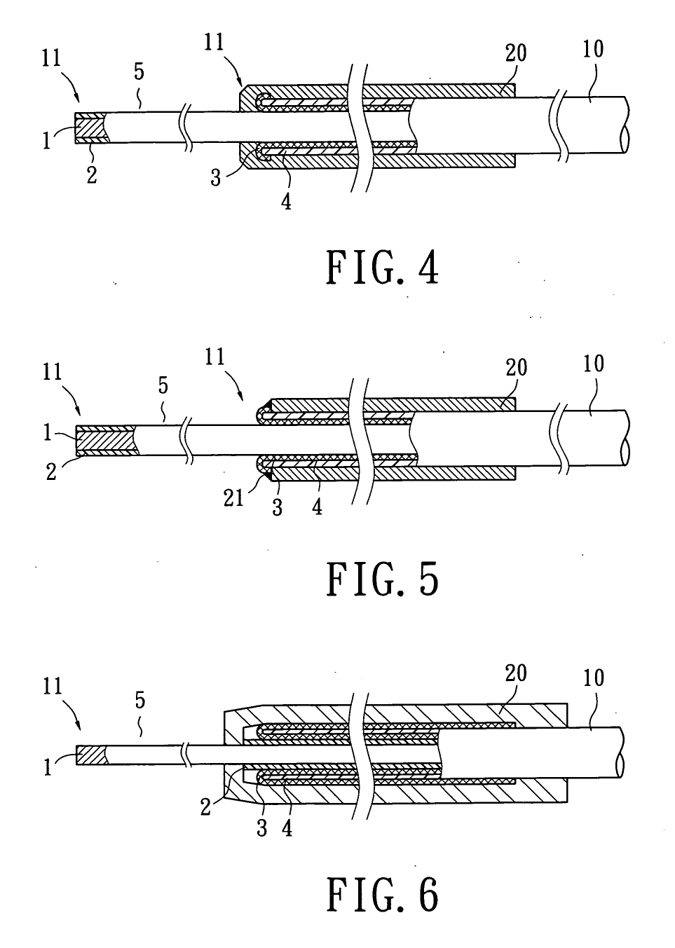

As shown in FIG. 4, an enlarged sectional view of second embodiment of coaxial cable antenna is illustrated. In which, a coaxial cable 10 is different from the same depicted in FIG. 3 of first embodiment, as the former being retained only a little bare braided sheath 3, which is folded backward covering a periphery of an outer plastic sheath 4 following receiver conductor 5 of a first end 11 of the coaxial cable 10. To match impedance and achieve a sufficient gain between the bare receiver conductor 5 and the braided sheath 3, a wrapper 20 enclosing the braided sheath 3 should be made from such as metal duct, carbon fiber duct etc. Thereby, the wrapper 20 can be electrically connected to the braided sheath 3.

### Third Embodiment

As shown in FIG. 5, an enlarged sectional view of third embodiment of coaxial cable antenna is illustrated. In which, a coaxial cable 10 is different from the same depicted in FIG. 10 of second embodiment, as the former being retained a little bare braided sheath 3, which is folded backward covering a periphery of an outer plastic sheath 4, and then welding said bare braided sheath 3 to a wrapper 20 securely by soldering tin, said wrapper 20 made from such as metal duct etc. After welding, it can be used to adjust tuned frequency.

### Fourth Embodiment

As shown in FIG. 6, an enlarged sectional view of fourth embodiment of coaxial cable antenna is illustrated. In which, a coaxial cable 10 is different from the same depicted in FIG. 3 of first embodiment, as the former being retained a receiver conductor 5 is a bare conductor core 1, which is not enclosed by an inner dielectric layer 2. Therefore, an inner dielectric layer 2 should be removed from a bare conductor core 1; the bare conductor core 1 is preferrably to have a larger diameter.

### Fifth Embodiment

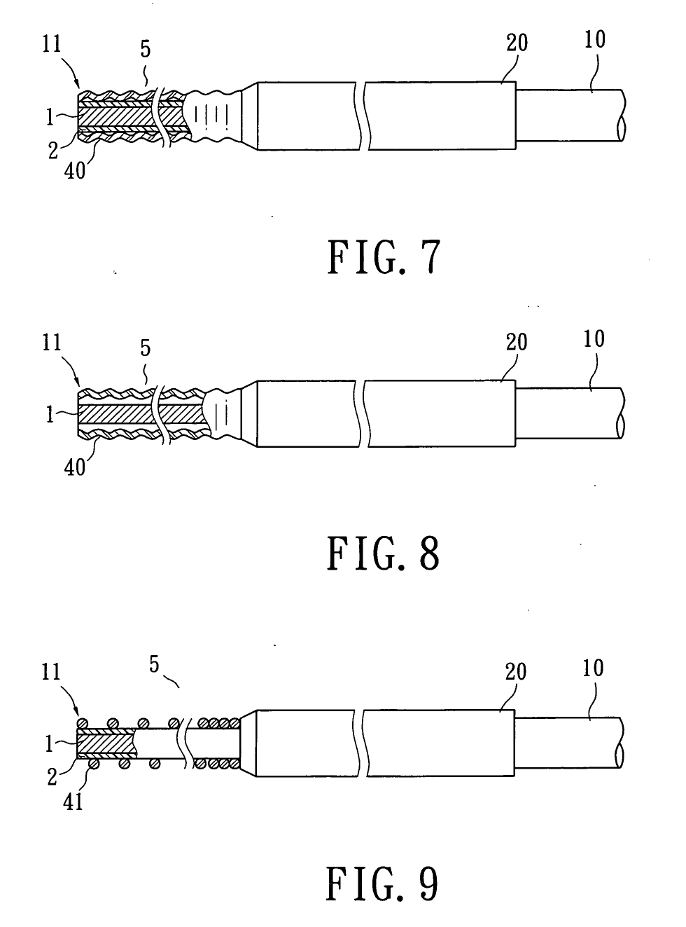

As shown in FIGS. 7˜8, enlarged sectional views of fifth embodiment of coaxial cable antenna are illustrated. In which, a coaxial cable antenna is accentuated by an elastic expander fit over a periphery of a receiver conductor 5. Said expander 40 can be selected from one of the following: rubber ring typed tube, plastic coil spring, metal coil spring, all of them are made of stretchable elastic material. The expander can be rectified to approach to an upright posture; a receiver conductor 5 fit through the expander can be accordingly drawn to an upright inclination promptly being flush with the expander. Thereby, a curved and retracted back receiver conductor 5 can be drawn straight to form a mast like antenna promptly.

### Sixth Embodiment

As shown in FIGS. 9˜10, enlarged sectional views of sixth embodiment of coaxial cable antenna are illustrated. In which, a coaxial cable antenna is accentuated by an expander 40 fit over a periphery of a receiver conductor 5. Said expander 40 can be a spring 41 selected from one of the following: plastic spring, metal spring. Based on the elasticity of the spring 41, a receiver conductor 5 can be drawn to a full stretched out length being flush with an upright-type expander instead of prior curved or bent posture inclination.

### Seventh Embodiment

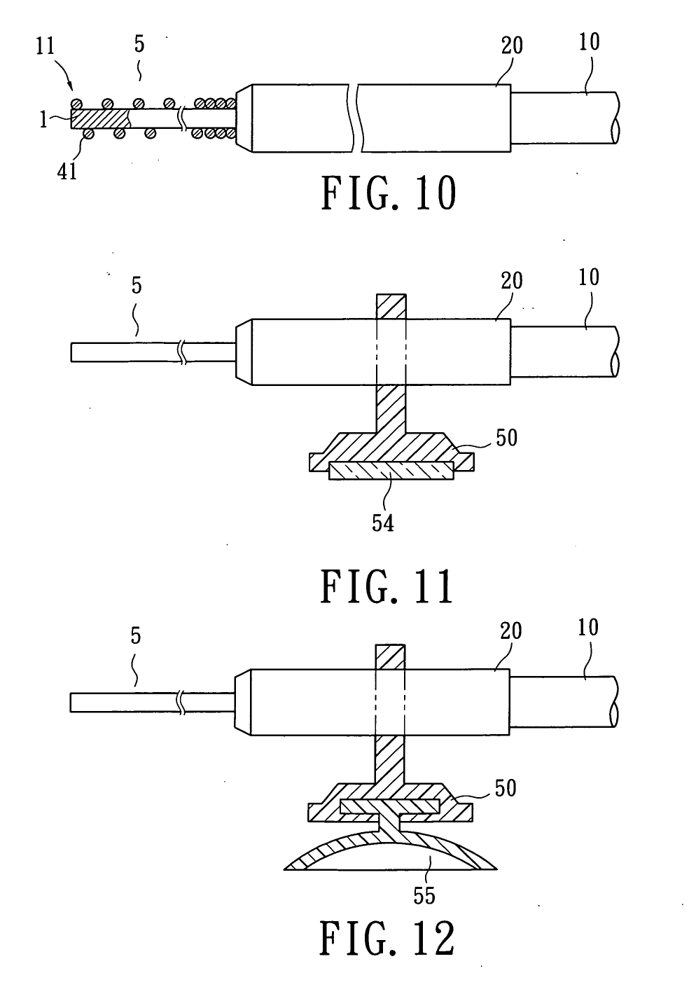

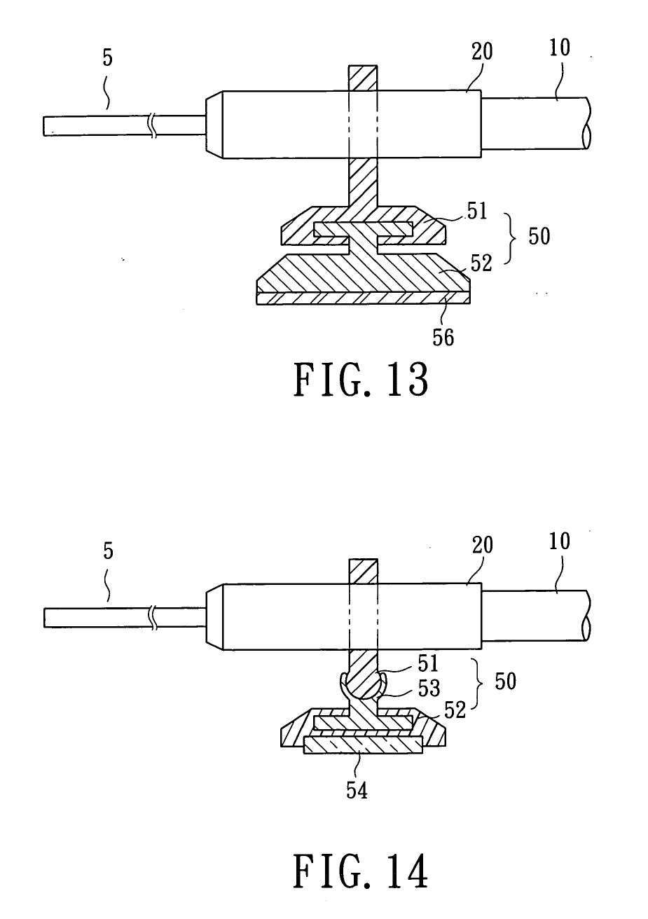

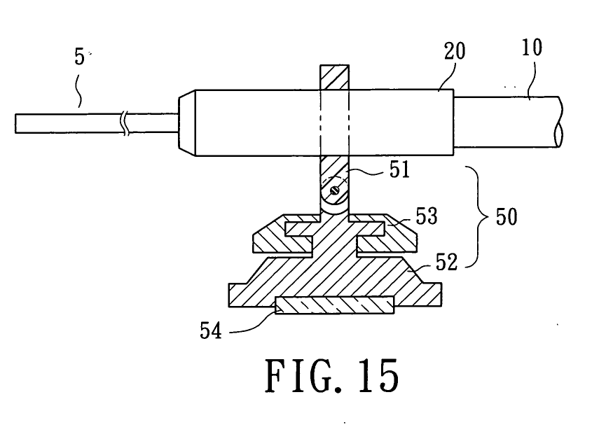

As shown in FIGS. 11˜15, enlarged sectional views of seventh embodiment of coaxial cable antenna are illustrated. In which, a coaxial cable antenna being accentuated that a receiver conductor 5 followed by a wrapper 20 at a first end 11 of a coaxial cable 10 is joined together by an affixture 50 attached to a planar surface of an object. Said affixture 50 is shaped as a positioning device, which can be taken apart with the coaxial cable at ease. A bottom side of said affixture 50 can be attached with one selected from the following: a magnet 54, a sucking disk 55, a double sided tape 56 . Besides, an affixture 50 can be divided into an upper, lower segments 51,52, or an upper, middle, lower segments 51,53,52 etc. These segments can be adjusted horizontally or vertically, or being adjusted at any angle as required. Thereby, a wrapper 20 and a receiver conductor 5 can be adjusted at will according to the requirements of receiving signals. No matter an affixture 50 is composed of two, three or more segments, once the affixture 50 is joined together to a wrapper 20 with the facility to adjust at an angle, it should be confined in the claim scope of the present invention.

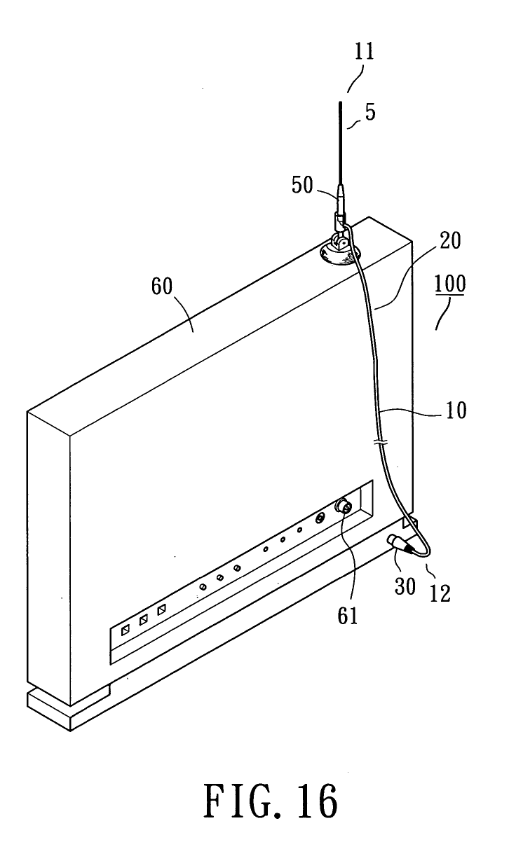

As shown in FIG. 16, a schematic view of a coaxial cable antenna in use is illustrated. In which, a digital TV 60 is equipped with an outlet 61 for plugging into or pulling out a connector 30 at a second end 12 of the coaxial cable 10. A wrapper 20 near a first end 11 of the coaxial cable 10 is attached to a surface of the digital TV by means of an affixture 50. The receiver conductor 5 receives broadband digital signals to show pictures on the screen of TV set.

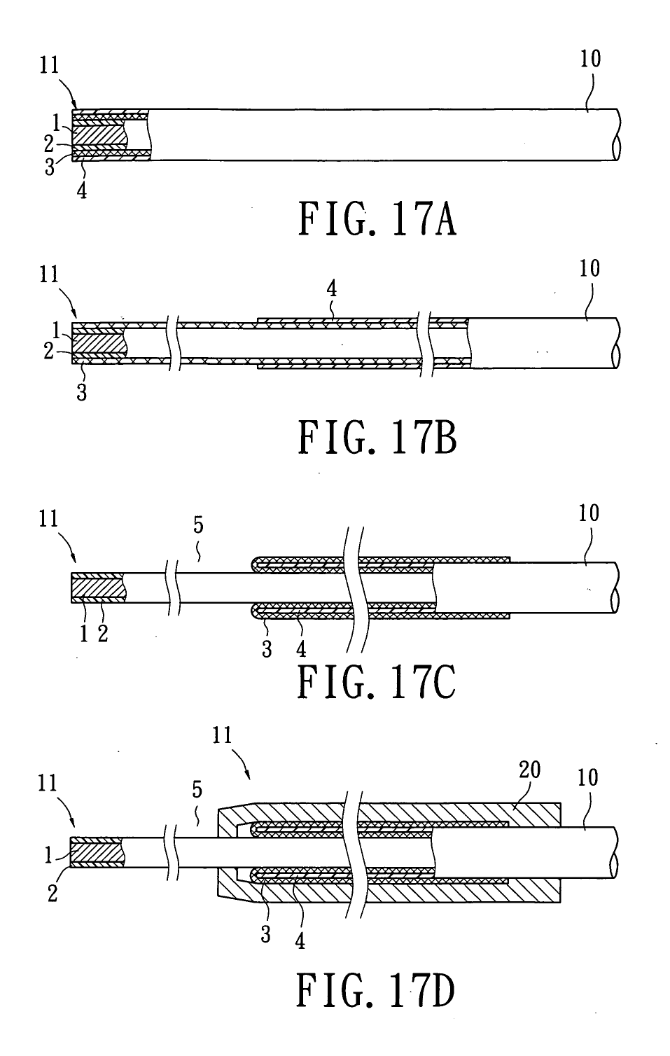

A method for making antenna of coaxial cable is further introduced as shown in FIGS. 17A˜17D comprising the following steps.
(a) as shown in FIG. 17A, getting an appropriate length of coaxial cable 10 having a first end 11 and a second end 12;
(b) as shown in FIG. 17B, peeling off an outer plastic sheath 4 at a first end 11 of the coaxial cable 10;
(c) as shown in FIG. 17C, peeling off a braided sheath 3 folded backward covering a periphery of an outer plastic sheath 4 following a receiver conductor at a first end of the coaxial cable 10 to form a segment of receiver conductor 5;
(d) as shown in FIG. 17D, enclosing a wrapper to a periphery of outer plastic sheath 4 following receiver conductor 5, the braided sheath 3 is also hidden inside the wrapper and in contact with the wrapper;
(e) as shown in FIG. 17E, connecting a second end 12 of a coaxial cable 10 to a connector 30 to transmit signals.

Moreover, according to the method for making antenna of coaxial cable as mentioned above, further comprising the following step.
(f) an expander has a facility to stretch upright instead of a curved, bent posture is applied to fit over a periphery of a receiver conductor 5, said expander made from elastic rubber ring type tube, or spring.

Next to an expander added to a receiver conductor 5, more steps can be processed as following:
(g) a wrapper 20 is joined together with an affixture 50, either a magnet 54, a sucking disk 55, or a double sided tape 56 can be selected one of them added to a bottom side of the affixture 50.

Moreover, a welding method can be applied to increase the electrical connection between the braided sheath 3 and the receiver conductor 5 comprising the following step:
(h) by welding, a front end of a wrapper 20, which is made from metal can be used as a conductor; is welded to a braided sheath 3 securely.

What is we claimed:

1. A coaxial cable antenna comprising:
a coaxial cable having a first end to receive signals, a second end to transmit signals, said first end includes a receiver conductor formed by a first end of the coaxial cable peeled off a specific length of braided sheath and outer plastic sheath, followed by a grounding segment led out from a periphery of the inner dielectric layer through a braided sheath and then folded backward covering a periphery of an outer plastic sheath;
a wrapper enclosing a periphery of an outer plastic sheath following a receiver conductor of a first end of said coaxial cable, the braided sheath is also hidden inside the wrapper in contact therewith;
a connector connected to a second end of said coaxial cable, the connector can be plugged into or pulled out at will to transmit signals.

2. A coaxial cable antenna according to claim 1 wherein a length of a braided sheath folded backward covering a periphery of an outer plastic sheath is relative to a length of a receiver conductor to match impedance between them.

3. A coaxial cable antenna according to claim 1 wherein a wrapper is a conductor to adjust a tuned frequency, further electrically connected to a braided sheath.

4. A coaxial cable antenna according to claim 3 wherein said conductor is a copper foil.

5. A coaxial cable antenna according to claim 3 wherein said conductor is selected from one of following: metal duct, carbon fiber duct.

6. A coaxial cable antenna according to claim 3 wherein said wrapper made from metal as a conductor secured to a braided sheath by welding.

7. A coaxial cable antenna according to claim 1 wherein a wrapper made of rubber like material as a nonconductor is to protect and decorate a receiver conductor.

8. A coaxial cable antenna according to claim 7 wherein said nonconductor is selected from one of the following: rubber ring type tube, contracted film, foam layer.

9. A coaxial cable antenna according to claim 1 wherein said receiver conductor is a bare conductor core not enclosed by an inner dielectric layer.

10. A coaxial cable antenna according to claim 1 wherein said receiver conductor is a conductor core enclosed by an inner dielectric layer.

11. A coaxial cable antenna according to claim 1 wherein an elastic material fits over a receiver conductor and rectify the receiver conductor upright being flush with the elastic material.

12. A coaxial cable antenna according to claim 11 wherein said elastic material is selected from one of the following: rubber ring type tube, plastic coil spring, metal coil spring.

13. A coaxial cable antenna according to claim 11 wherein said elastic material is selected from one of the following: plastic spring, metal spring.

14. A coaxial cable antenna according to claim 1 wherein said wrapper is joined together with an affixture attached to a planar surface of an object.

15. A coaxial cable antenna according to claim 14 wherein a bottom side of an affixture is added with one of the following: a magnet, a sucking disk, a double side tape.

16. A method for making a coaxial cable antenna comprising the following steps:
(a) getting an appropriate length of coaxial cable having a first end and a second end;
(b) peeling off an outer plastic sheath at a first end of the coaxial cable;
(c) peeling off a braided sheath and then folded backward covering a periphery of an outer plastic sheath following the first end of the coaxial cable to form a segment of receiver conductor;
(d) enclosing a wrapper to a periphery of outer plastic sheath following the receiver conductor, the braided sheath is also hidden inside the wrapper and in contact with the wrapper;
(e) connecting a second end of a coaxial cable to a connector to transmit signals.

17. A method for making a coaxial cable antenna according to claim 16 wherein further comprising a step as following:
(f) an expander has a facility to stretch upright from a curved, bent posture is applied to fit over a periphery of a receiver conductor, said expander made from elastic rubber ring typed tube, or spring.

18. A method for making a coaxial cable antenna according to claim 16 wherein next to an expander added to a receiver conductor, more steps can be processed as following:
(g) a wrapper is joined together by an affixture, one selected from following: a magnet, a sucking disk, a double sided tape can be added to a bottom side of the affixture.

19. A method for making a coaxial cable antenna according to claim 17 wherein next to an expander added to a receiver conductor, more steps can be processed as following:
(g) a wrapper is joined together by an affixture, one selected from following: a magnet, a sucking disk, a double sided tape can be added to a bottom side of the affixture.

20. A method for making a coaxial cable antenna according to claim 16 wherein a welding method can be applied to increase the electrically connection between the braided sheath and the receiver conductor comprising the following step.
(h) by welding, a front end of a wrapper, which is made from metal can be used as a conductor; welded to a braided sheath securely.
